(19) United States
(12) Patent Application Publication
(10) Pub. No.: US 2010/0281428 A1
(43) Pub. Date: Nov. 4, 2010

(54) IMAGE PROCESSING SYSTEM, DEVICE OPERATION SCREEN GENERATION METHOD, PROGRAM, AND INFORMATION PROCESSING APPARATUS

(75) Inventor: Ken Kuroda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/768,576

(22) Filed: Apr. 27, 2010

(30) Foreign Application Priority Data
May 1, 2009 (JP) 2009-112279

(51) Int. Cl. G06F 3/048

(52) U.S. Cl. 715/811

(57) ABSTRACT

An information processing apparatus registers processing executed by an image processing device as a button, acquires device information of the image processing device from the image processing device, and decides a hierarchy for displaying the registered buttons based on the acquired device information and contents of processing corresponding to the registered buttons. The apparatus groups a plurality of buttons which are decided to be displayed on a lower level into one or more groups, and makes one summary button correspond to each group. The apparatus generates operation screen information for displaying a button that is decided to be displayed on an upper level and the summary button that has been summarized on an operation screen, and sends the operation screen information to the image processing device. The image processing device displays an operation screen based on the received operation screen information and accepts a user operation.

### BACKGROUND OF THE INVENTION

1. Field of the Invention

The present invention relates to control for displaying information on a user interface of an image processing device.

2. Description of the Related Art

Known systems that are displayed on a user interface (hereafter, referred to as “UI”) of an image processing apparatus (hereafter, referred to as “device”) such as a multifunction apparatus include a system that has a plurality of screen pages and a system that is displayed in order from buttons which have a high possibility of being desired by the user (see Japanese Patent Application Laid-Open No. 2000-137731).

Thus, since it is not necessary to mount a new UI on the device side each time a new model of the device is developed, the development man-hours can be reduced. Further, since information is collectively managed on a PC application side, there is the advantage that the same information can be used from all devices.

In recent years, information of PC (personal computer) applications has been increasing on copiers or printers. Further, there is an increasing tendency to create display screen information on the PC application side, and display the created screens as they are on the UI of a device.

Meanwhile, a “one-touch button” function that previously registers processing settings in a single button so that a user does not have to perform complicated operations when standing in front of a device is being widely utilized. By utilizing this function, the user need only press a desired button, and thus the operation load of the user can be reduced.

### SUMMARY OF THE INVENTION

An image processing system comprises an image processing device, and an information processing apparatus that generates an operation screen of the image processing device and sends the operation screen to the image processing device. The information processing apparatus comprises a registration unit that registers processing executed by the image processing device as a button, a device information acquisition unit that acquires device information of the image processing device from the image processing device, a decision unit that decides a hierarchy for displaying the registered buttons based on device information acquired by the device information acquisition unit and contents of processing corresponding to buttons registered by the registration unit, a button summarizing unit that groups a plurality of buttons which the decision unit decides to display on a lower level into one or more groups, and makes one summary button correspond to each group, and a screen generation unit that generates operation screen information for displaying a button that the decision unit decides to display on an upper level and the summary button that has been summarized by the button summarizing unit on an operation screen, and sends the operation screen information to the image processing device. The image processing device comprises a device information notification unit that notifies device information of the image processing device to the information processing apparatus, and a user interface unit that displays an operation screen based on the operation screen information received from the information processing apparatus and accepts a user operation.

Further features of the present invention will become apparent from the following description of exemplary embodiments with reference to the attached drawings.

### BRIEF DESCRIPTION OF THE DRAWINGS

FIG. 1 is a view that illustrates an outline of a print system to which the present invention can be applied.

FIG. 2 is a software configuration diagram of a PC application 102.

FIG. 3 is a hardware configuration diagram of a device.

FIG. 4 is a software configuration diagram of the device.

FIG. 5 is a view that illustrates one-touch button registration information.

FIG. 6 is a view that illustrates account information of a user.

FIG. 7 is a view that illustrates a communication sequence between the PC application 102 and the device.

FIG. 8 is a view that illustrates a button grouping decision table.

FIG. 9 is a flowchart that illustrates operations of a PC application 102 of Embodiment 1.

FIG. 10 is a view that illustrates a screen display example of Embodiment 1.

FIG. 11 is a flowchart that illustrates operations of a PC application 102 of Embodiment 2.

FIG. 12 is a view that illustrates a screen display example of Embodiment 2.

FIG. 13 is a view that illustrates a screen display example for describing a technical premise.

FIG. 14 is a view that illustrates a screen display example for describing the technical premise.

### DESCRIPTION OF THE EMBODIMENTS

Preferred embodiments of the present invention will now be described in detail in accordance with the accompanying drawings.

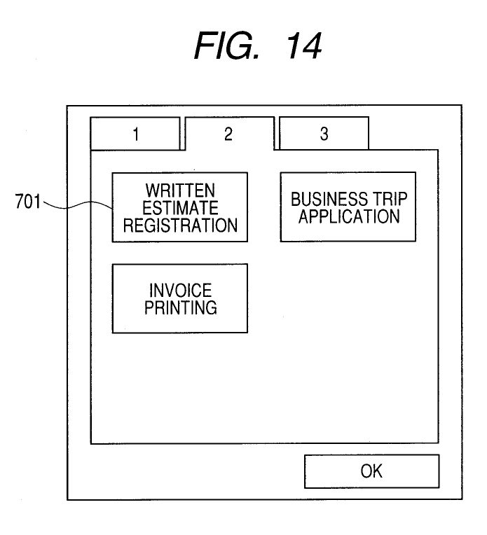

First, a screen display example that illustrates a technical premise of the embodiments is described using FIG. 13 and FIG. 14.

FIG. 13 and FIG. 14 are views that illustrate a conventional screen display example.

As shown in FIG. 13, a screen 601 is a touch panel that is a display region of a screen mounted on a device. The system determines that a one-touch button has been pressed when a user touches the screen.

Tabs 602, 603, and 604 indicate that there are three screens. When it is not possible to display all of a plurality of buttons on the tab 602, the remaining buttons are displayed on the tab 603. If all of the buttons cannot be displayed even by using the tab 603, the remaining buttons are displayed on the tab 604. When the system detects that the user has pressed any one of the tabs 602, 603, and 604, the system displays the corresponding screen.

According to this example, up to six one-touch buttons 605 can be displayed on a single screen, and thus a total of 18 buttons can be displayed with the three tabs. When the user presses a desired button, the system reads out the processing contents that are recorded for the relevant button and performs the specified processing.

When the one-touch button desired by the user is not present on the displayed screen, the user presses the tab 603 or the tab 604 to search for the desired one-touch button on another screen. When an OK button 606 is pressed, the system changes the display screen to the initial screen display of a predetermined copy processing screen or the like of the device.

FIG. 14 is a screen display example in a case where the screen of tab 603 is being displayed. Three one-touch buttons 701 which could not be displayed on the tab 602 are displayed on the tab 603.

In this connection, a problem with the conventional screen display is that when there is a large number of registered buttons, as shown in FIG. 13 and FIG. 14, it is not possible to display all the buttons on a single screen, and it is difficult to search for a desired button.

However, when there is a plurality of screen pages, it is necessary to update the pages in order to find a desired button. Since it is necessary to exchange screen display information with a PC application via a network each time a page is updated, there has been a problem of poor display responsiveness.

Further, it has not been possible to adequately determine buttons that have a high possibility of being desired by the user by merely distinguishing the buttons based on keywords included in static button information. Furthermore, in such cases, there have been quite a number of situations in which users become confused because they are unable to intuitively grasp the order in which the buttons are arranged and cannot locate a desired button.

Hereunder, an example of an embodiment of the present invention is described that takes at least one part of the aforementioned problems into consideration.

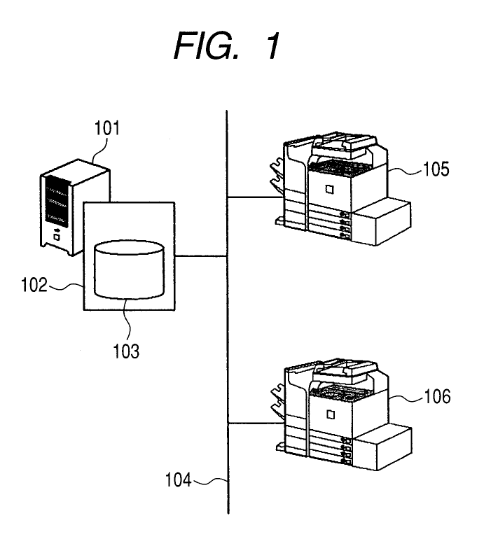

FIG. 1 is a view that illustrates an outline of an image processing system to which the present invention can be applied.

A personal computer (hereunder, referred to as “PC”) shown in FIG. 1 includes a CPU and hardware components such as a RAM, a ROM, a HDD, and a network interface card (NIC). The PC 101 is connected to image processing apparatuses (image processing devices (hereunder, referred to as “device”) 105 and 106 such as a copier, printer, or multifunction apparatus via a network 104. Although an example is illustrated in FIG. 1 in which the device 105 and device 106 are connected to the network 104, any number of devices may be connected. The device 105 and device 106 may be different kinds to each other. Hereunder the device 105 and device 106 are referred to simply as “device”.

A PC application 102 is application software that operates on the hardware of the PC 101, and enables accumulation and storage of documents. The PC application 102 is implemented by the CPU of the PC 101 loading a program stored on the HDD or the like onto the RAM and executing the program. A document management database 103 is a database that manages document data in electronic form and is provided on the HDD or the like of the PC 101.

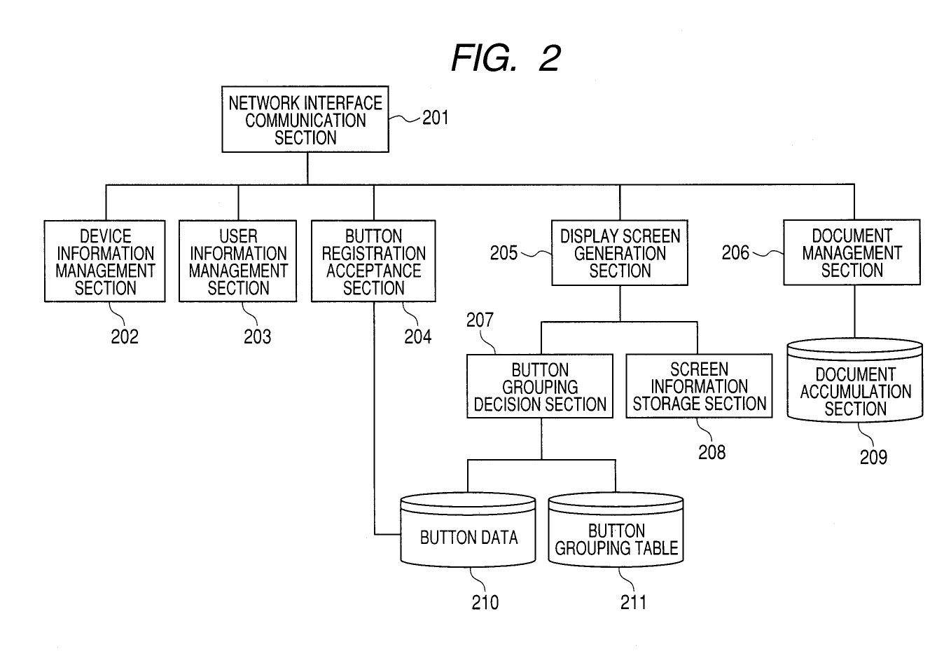

FIG. 2 is a software configuration diagram of the PC application 102.

A network interface communication section 201 shown in FIG. 2 exchanges screen information with devices on the network and receives equipment information of devices or the status of devices through the network 104.

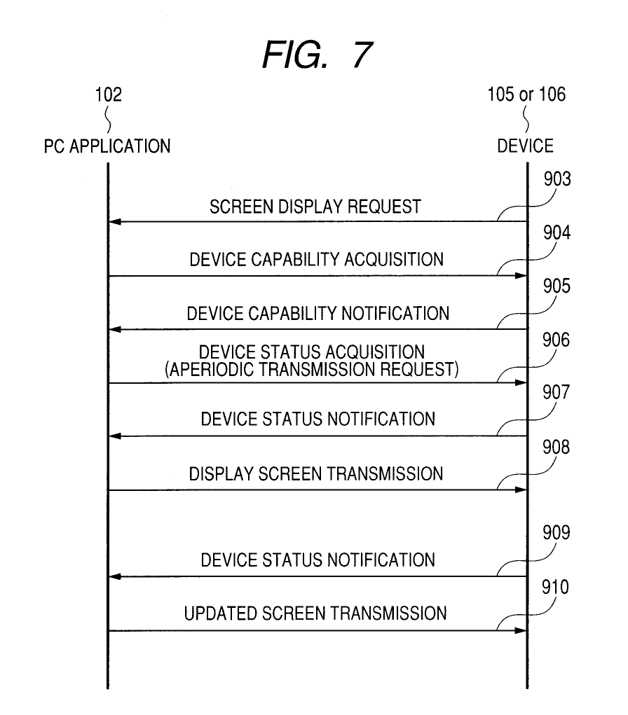

A device information management section 202 stores and manages device information (device capability information and device status information) that the network interface communication section 201 receives from devices by device information acquisition processing, as described later using FIG. 7, for each device. A user information management section 203 stores and manages account information (FIG. 6) such as a login ID and password of a user that utilizes the PC application 102.

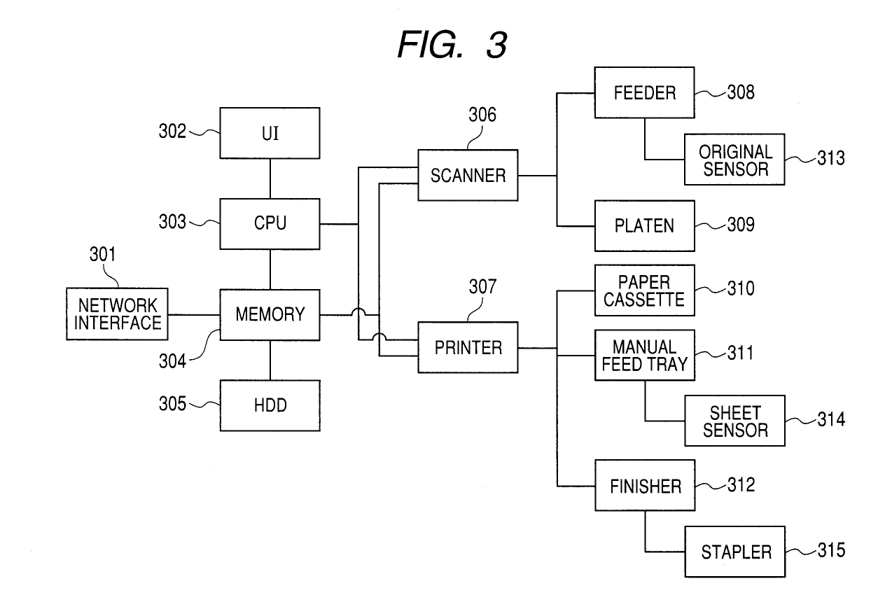

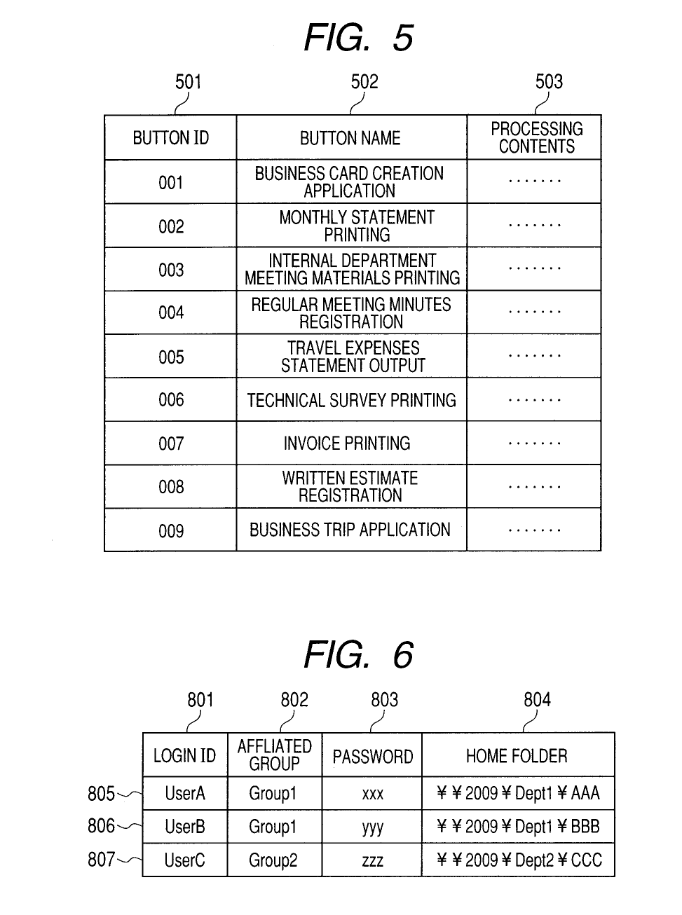

A button registration acceptance section 204 accepts registration information for one-touch buttons displayed on the UI on the device, and stores the registration information (FIG. 5) in button data 210. The registration information for a one-touch button includes a button name that is accepted from a user and processing contents that are executed when the relevant button is pressed. The user can register a one-touch button from a UI 302 (FIG. 3) of the device, or from the PC 101, or from another PC that can communicate with the PC 101. The one-touch button registration information may be common for all users, or different for each user, or selectable as different for each user or common to all users at the time of registration.

A display screen generation section 205 generates screen information of a screen to be displayed on the UI of a device, and transmits the screen information to the device via the network interface communication section 201 (device operation screen generation processing). A button grouping decision section 207 refers to a button grouping table 211 and dynamically decides which one-touch buttons to display at which locations on a display screen (that is, which buttons to display on the upper level, and which buttons to display on a lower level). The details of the decision method are described later using a flowchart.

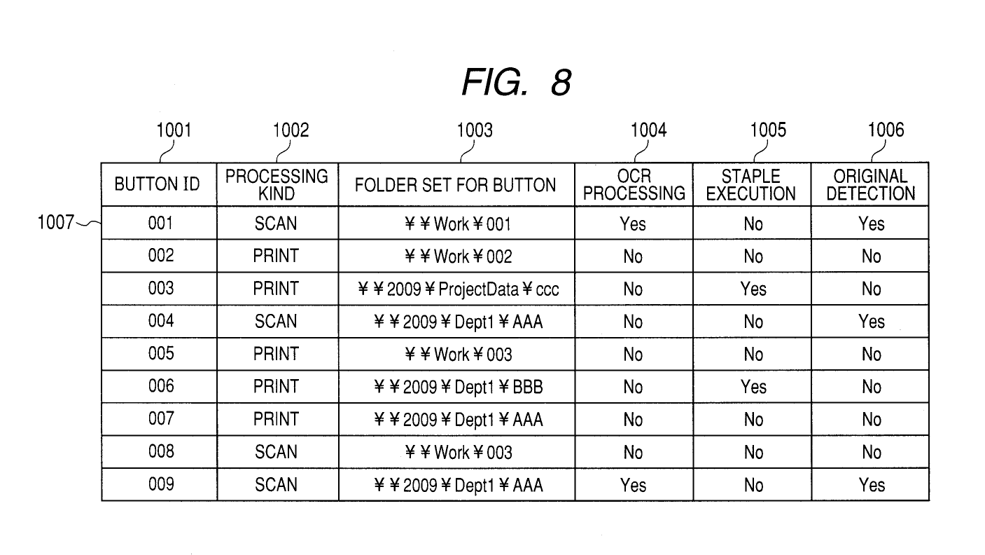

A screen information storage section 208 stores a display state (display button information) of a screen that is currently being displayed for each device. The button grouping table 211 stores a button grouping decision table shown in FIG. 8, described later, and information regarding one-touch buttons associated with a summary button as described later.

A document management section 206 accumulates and manages image data of documents that have been converted into electronic form by scanning with a scanner of a device as well as attribute information of the documents in a document accumulation section 209. The image data is managed by a folder structure. A folder can have a plurality of image data and a plurality of subfolders. The folder hierarchy is represented as a folder path.

FIG. 3 is a hardware configuration diagram of a device.

In FIG. 3, a CPU 303 is a central processing unit that controls each operation of the device. A network interface 301 performs data communication through the network 104. A UI 302 is a user interface section that displays information to a user and accepts inputs from a user.

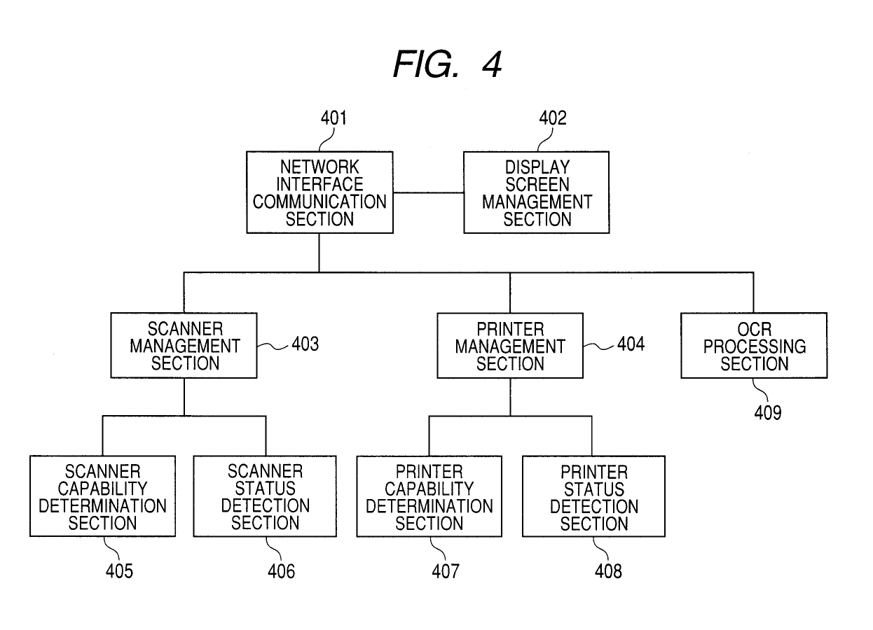

A memory 304 is a primary memory for accumulating and processing image data or data operations for the device to operate. A HDD 305 is a hard disk drive that is a secondary memory for accumulating and processing image data or data operations. A software program of the device is also stored on the HDD 305 and is executed by the CPU 303. The software configuration of the device is described later using FIG. 4.

A scanner 306 controls a feeder 308 and a platen 309 in order to scan an original and convert the original into image data. The feeder 308 is an original feeding apparatus for successively scanning a plurality of originals. The feeder 308 is equipped with an original sensor 313 that detects that an original has been placed thereon. The original sensor 313 can detect an original size in standard size units according to the AB system or inch system. The platen 309 is a scanning apparatus that optically scans an original to convert the original into electronic image data.

A printer 307 controls a paper cassette 310, a manual feed tray 311, and a finisher 312 to print image data on a paper sheet. Paper sheets for printing are stacked in advance in the paper cassette 310, and the paper cassette 310 feeds the number of sheets required for printing.

The manual feed tray 311 is a tray in which a user arbitrarily places sheets that the user wishes to use for printing. In general, the manual feed tray 311 is normally in a state in which sheets are not placed thereon. The manual feed tray 311 is equipped with a sheet sensor 314 that detects that a sheet has been placed on the tray.

The finisher 312 performs processing such as sorting printed sheets and stapling sheets together to form bundles. A stapler 315 is connected to the finisher 312. The stapler 315 holds staples and performs a stapling process that staples sheets together.

Next, the software configuration of a device is described using FIG. 4.

FIG. 4 is a software configuration diagram of a device.

In FIG. 4, a network interface communication section 401 conducts data communication with the PC application 102 via the network 104. The display screen management section 402 stores and manages screen information to be displayed on the UI 302.

A scanner management section 403 manages an operating state of the scanner 306. A scanner capability determination section 405 determines an apparatus connection state and the processing capability of the scanner 306, the feeder 308, the original sensor 313, and the platen 309. A scanner status detection section 406 likewise monitors the operating state of the scanner 306, the feeder 308, and the platen 309, and detects an input from the original sensor 313 and various error occurrence statuses.

A printer management section 404 manages an operating state of the printer 307. A printer capability determination section 407 determines an apparatus connection state and the processing capability of the printer 307, the paper cassette 310, the manual feed tray 311, the sheet sensor 314, the finisher 312, and the stapler 315. A printer status detection section 408 likewise monitors the operating state of the printer 307, the paper cassette 310, the manual feed tray 311, the sheet sensor 314, the finisher 312, and the stapler 315, and detects an input from the sheet sensor 314 and various error occurrence statuses.

An OCR processing section 409 identifies characters by comparing handwritten characters and printed characters included in image data obtained by scanning with the platen 309 and previously stored patterns. The characters “OCR” are an abbreviation of “Optical Character Reader”. Characters that are scanned as an image are converted to electronic character data using the OCR processing section 409, and are transferred to the PC application 102 together with the original image data.

Device information managed at the scanner management section 403 and printer management section 404 is notified to the PC application 102 by device information notification processing as described later using FIG. 7.

The respective functional sections of the device as denoted by the above reference numerals 401 to 409 are realized by the CPU 303 reading out and executing a program stored in the HDD 305.

FIG. 5 is a view that illustrates one-touch button registration information that is stored in the button data 210.

In FIG. 5, a button ID 501 is a management number that is uniquely allocated to each button. A button name 502 is a display button name, and is the character string that is actually displayed on the screen for the relevant button. Processing contents 503 shows the processing contents executed when the relevant button is pressed (the details are omitted from FIG. 5). In the example shown in FIG. 5, nine one-touch buttons with button IDs “001” to “009” are registered.

FIG. 6 is a view that illustrates account information of users that is managed by the user information management section 203 of the PC application 102.

As shown in FIG. 6, the account information of a user includes a login ID 801, an affiliated group 802, a password 803, and a home folder 804.

The password 803 is encoded and managed as data. The home folder 804 is a standard folder path that is allocated for each login ID. Unless otherwise specified by the user, image data of a scanned document is placed in the home folder. When a device is utilized by a plurality of users, since it is troublesome to distinguish which user is the possessor of image data if users share a single folder, a standard folder is individually allocated for each user. According to the example illustrated in FIG. 6, three user accounts are registered, namely, User A (805), User B (806), and User C (807).

Next, a communication sequence between the PC application 102 and a device is described using FIG. 7.

FIG. 7 is a view that illustrates a communication sequence between the PC application 102 and a device.

As shown in FIG. 7, first, upon determining that a screen of the PC application 102 is to be displayed, the device sends a screen display request 903 to the PC application 102. Upon receiving the screen display request 903, the PC application 102 sends a device capability acquisition command 904.

Upon receiving the device capability acquisition command 904, the device sends the connection status of apparatuses connected to its own device and the processing capability thereof as a device capability notification 905. In this connection, the connection information of apparatuses connected to the device is information such as, for example, that the feeder 308 or the finisher 312 is connected. Further, the term “processing capability” of apparatuses connected to the device refers to information such as, for example, the maximum number of original sheets that can be scanned at one time, the maximum number of copies that can be printed at the same time, or that the device is equipped with the OCR processing section 409. Both the connection information and the information regarding the processing capability of apparatuses are managed at the scanner management section 403, the printer management section 404, or the OCR processing section 409.

Upon receiving the device capability notification 905, the PC application 102 stores the relevant capability information of the device that is received in the device information management section 202 separately for each device.

Subsequently, the PC application 102 transmits a device status acquisition request 906 to the device. Upon receiving the device status acquisition request 906, the device sends the operating status of the device that is managed by the scanner management section 403 or the printer management section 404 and various error occurrence statuses as a device status notification 907 to the PC application 102. The device status notification 907 includes error status information and user operation status information that shows information regarding a change in the status of the device that is caused by a user operation. The error status information, for example, includes a “no staple” error or a “no staple” error cancellation of the stapler 315. The user operation status information includes, for example, information detected by the original sensor 313 and information detected by the sheet sensor 314. The device status notification 907 is sent together with information identifying the device and the login ID of the user that is logged in.

Upon receiving the device status notification 907, the PC application 102 stores the device error status and user operation status in the device information management section 202 separately for each device. Based on the device information received by the above procedures, the PC application 102 generates operation screen information (display screen information) to be displayed on the UI 302 of the device with the display screen generation section 205, and sends the generated display screen information to the device (display screen transmission 908).

Upon receiving the display screen information, the device stores the display screen information in the display screen management section 402, and displays a screen that is based on the relevant display screen information on the UI 302.

Thereafter, the device monitors by itself the device status (device error status or user operation status) that shows the operating status of the device, and various error occurrence statuses and cancellation states as described above. Each time there is a change in the device status, the device notifies the PC application 102 of such change by sending a device status notification 909. Upon receiving the device status notification 909, the PC application 102 updates the device information management section 202 based on the received device status. Further, based on the received device status described above, the PC application 102 generates screen information to be displayed at the device with the display screen generation section 205, and sends the generated screen information to the device (display screen transmission 908). Upon receiving the display screen information, the device updates the display screen management section 402 with the display screen information, updates the screen of the UI 302 with the display screen information, and accepts a user operation.

FIG. 8 is a view that illustrates a button grouping decision table that is used when grouping one-touch buttons. The button grouping decision table is generated with information that is input when registering a one-touch button, and is stored in the button grouping table 211. The button grouping decision table is used when deciding the groupings of one-touch buttons at the button grouping decision section 207.

In FIG. 8, a button ID 1001 is the same as the button ID 501 described in FIG. 5, and is a management number that is uniquely allocated for each one-touch button. A processing kind 1002 shows the classifications of the principal processing performed at the device, and is classified into scan processing or print processing.

A folder set for button 1003 is one piece of attribute information for the one-touch button that is registered in the button data 210. The folder set for button 1003 shows which folder path of the document accumulation section 209 the system accumulates the scanned image data in when the relevant button is pressed, or which folder path the image data to be printed when the relevant button is pressed is accumulated in.

OCR processing 1004 indicates whether or not a setting is made to perform OCR processing when the respective one-touch buttons are pressed. Staple execution 1005 similarly indicates whether or not to perform staple processing when the respective one-touch buttons are pressed.

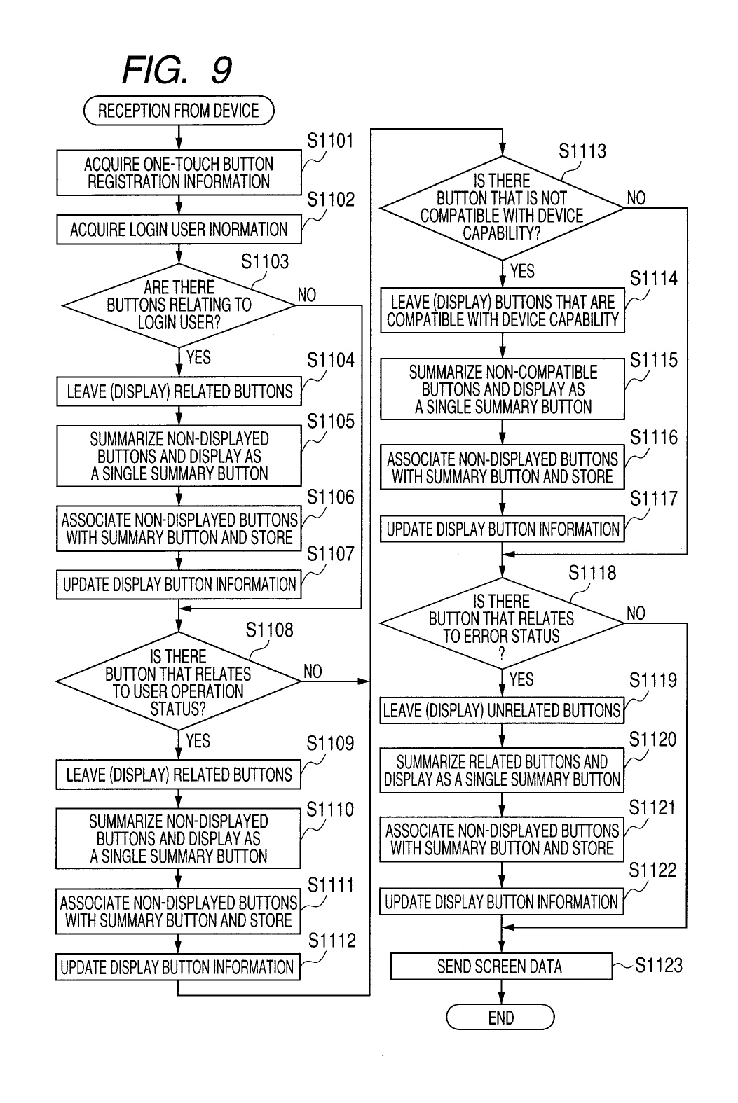

Original detection 1006 indicates whether or not to regard the relevant button as a one-touch button that is desired by the user when the original sensor 313 connected to the feeder 308 detects an original. Since the original detection 1006 is an item for which the detection result changes according to a user operation, the original detection 1006 is one item included in “user operation status”. The user operation status also includes, for example, a status that is detected upon a user placing an original in the manual feed tray 311. The user operation status will be described further in the description regarding FIG. 9.

Even when an original is placed in the feeder 308, it is not necessarily the case that one-touch buttons for which the processing kind 1002 is scan are all one-touch buttons desired by the user. Because the original sensor 313 can only detect original sizes that are according to the standard size units, the feeder is not used for processing that uses non-standard size originals. Therefore, even if an original is detected by the original sensor 313, one-touch buttons that include processing to scan a non-standard size original are not regarded as one-touch buttons that are desired by the user, and a decision is made not to display (display on a lower level) the one-touch buttons in question.

For example, for the one-touch button with the button ID “008”, although the processing kind 1002 is “scan”, the original detection 1006 setting is “No”. This is because for the one-touch button with the name “Written Estimate Registration” that corresponds to the button ID “008”, a written estimate to be scanned is a non-standard size.

Hereunder, the operations of the PC application 102 when device status notifications 907 and 909 are received from a device are described in detail using the flowchart in FIG. 9.

FIG. 9 is a flowchart that illustrates operations of the PC application 102 when the device status notification 907 or 909 is received from a device. More specifically, the processing of this flowchart is implemented by the CPU of the PC 101 loading a program stored in the HDD onto the RAM and executing the program. In this case, it is assumed that the one-touch button registration information is common to all users.

Upon receiving the device status notification 907 or 909 from a device, the display screen generation section 205 of the PC application 102 operating on the PC 101 performs the following processing.

First, in step S1101, the display screen generation section 205 acquires one-touch button registration information (FIG. 5) from the button data 210 via the button grouping decision section 207, and takes the one-touch button registration information to be the information of the display candidates.

Next, in step S1102, the display screen generation section 205 acquires user information of the login user from the user information management section 203 based on the login ID attached to the device status notification (user information acquisition processing).

Next, in step S1103, the display screen generation section 205 causes the button grouping decision section 207 to decide whether or not there is a one-touch button relating to the login user among the display candidates. As the decision method, the button grouping decision section 207 decides whether or not information of the home folder 804 of the login user acquired from the user information management section 203 is included in the file path of the folder set for button 1003 of the button grouping decision table in FIG. 8. A one-touch button for which the home folder 804 is included in the folder 1003 is determined to be related to the login user. In contrast, a one-touch button for which the home folder 804 is not included in the folder 1003 is determined to be unrelated to the login user.

For example, a case will be described in which “User A” 805 performs a user operation. According to this example, since the home folder 804 of “User A” 805 is “¥¥2009¥Dept1¥AAA”, the button grouping decision section 207 decides whether or not the same folder path exists in the folder set for button 1003. As a result, it is determined that three one-touch buttons with the button IDs “004”, “007”, and “009” relate to the login user.

When it is determined in the above described S1103 that there is a one-touch button related to the login user, the button grouping decision section 207 proceeds to the processing in step S1104. In contrast, when it is determined that there is no one-touch button related to the login user, the display screen generation section 205 is notified to that effect, and the display screen generation section 205 proceeds to the processing in step S1108.

In step S1104, the button grouping decision section 207 decides to display the buttons relating to the login user among the display candidates as they are as one-touch buttons (display on the upper level). More specifically, the button grouping decision section 207 decides to retain the buttons relating to the login user as display candidates. In the above described example, since the three one-touch buttons with the button IDs “004”, “007”, and “009” relate to the login user, the button grouping decision section 207 decides to display these buttons as one-touch buttons (display on the upper level).

Next, in step S1105, the button grouping decision section 207 decides to display buttons that are not related with the login user among the display candidates as a “summary button” (display on a lower level). In the aforementioned example, since buttons with the button IDs “001”, “002”, “003”, “005”, “006”, and “008” are not related with the login user, it is decided to display these buttons as a “summary button” (display on a lower level). The button grouping decision section 207 notifies the result determined in the aforementioned S1104 and S1105 to the display screen generation section 205.

Next, in step S1106, the display screen generation section 205 groups (summarizes) zero or more one-touch buttons that are not displayed (displayed as a summary button) into one or more groups. The display screen generation section 205 associates a single summary button with each group, respectively, and stores the result in the button grouping table 211 (button summarization processing).

The summarization method employed when summarizing buttons in the flowchart in FIG. 9 is according to information in the button grouping decision table shown in FIG. 8 that is designated by the system administrator. For example, when the summarization method is set so as to summarize buttons by the processing kind 1002, the system summarizes buttons into two summary buttons that correspond to “scan” and “print” that are classified under the processing kind 1002.

In the aforementioned example, since the processing kind 1002 of the one-touch buttons with the button IDs “001” and “008” is “scan”, these buttons are summarized under a “scan” summary button. Further, since the processing kind 1002 of the one-touch buttons with the button IDs “002”, “003”, “005”, and “006” is “print”, these buttons are summarized under a “print” summary button.

Further, in step S1107, the display screen generation section 205 updates the display screen information of the screen information storage section 208 according to the decisions made in the aforementioned S1104 and S1105. At this time, the display candidates are also updated. In the above example, the display candidates at this time are three one-touch buttons with the button IDs “004”, “007”, and “009”.

Next, in step S1108, the display screen generation section 205 causes the button grouping decision section 207 to decide whether or not there is a button among the display candidates that relates to a user operation status in the device status notification that is received.

As described above with respect to the device status notifications 907 and 909 of FIG. 7, the user operation status includes a status that is detected by the original sensor 313 and a status that is detected by the sheet sensor 314. In the button grouping decision table shown in FIG. 8, the original detection 1006 is an attribute that relates to the user operation status. In the aforementioned example, among the buttons with the button IDs “004”, “007”, and “009” that are display candidates, the original detection 1006 is “Yes” for the two one-touch buttons with the button IDs “004” and “009”. Hence, when “original detection” is included as a user operation status in a received device status notification, it is decided that the buttons with the button IDs “004” and “009” relate to the user operation status.

If it is determined in the aforementioned S1108 that there is a button relating to the user operation status in the received device status notification, the button grouping decision section 207 proceeds to the processing in step S1109.

In contrast, in the aforementioned S1108, if it is determined that there is no button relating to the user operation status in the received device status notification, the button grouping decision section 207 notifies the display screen generation section 205 to that effect. Upon receiving the notification, the display screen generation section 205 proceeds to the processing in step S1113.

In step S1109, similarly to the aforementioned S1104, the button grouping decision section 207 decides to display the buttons relating to the received user operation status among the display candidates as they are as one-touch buttons (display on the upper level). More specifically, the button grouping decision section 207 decides to retain the buttons relating to the user operation status (in the above example, the buttons with button IDs “004” and “009”) as display candidates.

Next, in step S1110, similarly to the above described S1105, the button grouping decision section 207 decides to display a button that is not related with the received user operation status among the display candidates (in the above example, the button with the button ID “007”) as a “summary button” (display on a lower level). The button grouping decision section 207 then notifies the result determined in the aforementioned S1109 and S1110 to the display screen generation section 205.

Next, in step S1111, similarly to the above described S1106, the display screen generation section 205 associates zero or more one-touch buttons that are not displayed (displayed as a summary button) and a “summary button” and stores the result in the button grouping table 211. In the above described example, since the processing kind 1002 of the button with the button ID “007” is “print”, the display screen generation section 205 summarizes the button with the button ID “007” under the “print” summary button.

Further, in step S1112, similarly to the above described S1107, the display screen generation section 205 updates the display screen information of the screen information storage section 208 according to the decisions made in the aforementioned S1109 and S1110. At this time, the display candidates are also updated. In the above example, the display candidates at this time are two one-touch buttons with the button IDs “004” and “009”.

Next, in step S1113, the display screen generation section 205 causes the button grouping decision section 207 to decide whether or not there is a button among the display candidates that is not compatible with the device capability that is managed by the device information management section 202. The “device capability” is as described above with respect to the device capability notification 905 of FIG. 7. In the button grouping decision table shown in FIG. 8, the OCR processing 1004 is an attribute that is influenced by the device capability. In the aforementioned example, of the two buttons with the button IDs “004” and “009” that are display candidates, the OCR processing 1004 is set to “Yes” for the one-touch button with the button ID “009”. Hence, if “OCR processing” is not included in the device capability, the button with the button ID “009” is determined to be incompatible with the device capability (a button corresponding to processing that cannot be executed by the device). Since the device shown in FIG. 4 has OCR processing capability, the one-touch button with the button ID “009” is determined to be compatible with the device capability (a button corresponding to processing that can be executed by the device).

In the above described S1113, if it is determined that there is a one-touch button that is not compatible with the device capability (one-touch button that corresponds to processing that is not executable with the device), the button grouping decision section 207 proceeds to the processing of step S1114. In contrast, if it is determined that there is no one-touch button that is not compatible with the device capability, the button grouping decision section 207 notifies the display screen generation section 205 to that effect, and the display screen generation section 205 proceeds to the processing of step S1118.

In step S1114, the button grouping decision section 207 decides to display the buttons compatible with the device capability (buttons that correspond to processing that is executable with the device) among the display candidates as they are as one-touch buttons (display on the upper level). More specifically, the button grouping decision section 207 decides to retain the compatible buttons as display candidates. According to the aforementioned example, it is decided not to summarize the buttons with the button IDs “004” and “009” that are display candidates because the buttons are compatible with the device capability.

Next, in step S1115, the button grouping decision section 207 decides to display buttons that are not compatible with the device capability (buttons that correspond to processing that is not executable with the device) among the display candidates as a single “summary button” (display on a lower level). More specifically, the button grouping decision section 207 decides to remove the buttons that are not compatible with the device capability from the display candidates. The button grouping decision section 207 then notifies the results determined in the aforementioned S1114 and S1115 to the display screen generation section 205.

Next, in step S1116, according to the decision in the above described S1115, the display screen generation section 205 associates zero or more one-touch buttons that are not to be displayed (to be displayed as a summary button) and a “summary button”, and stores the result in the button grouping table 211.

Further, in step S1117, according to the decisions in the above described S1114 and S1115, the display screen generation section 205 updates the display screen information of the screen information storage section 208. At this time, the display screen generation section 205 also updates the display candidates. According to the above described example, at this time the two buttons with the button IDs “004” and “009” are the display candidates.

Next, in step S1118, the display screen generation section 205 causes the button grouping decision section 207 to decide whether or not there is a button among the display candidates that relates to an error status in the device status notification that is received. As described with respect to the device status notifications 907 and 909 of FIG. 7, in the button grouping decision table in FIG. 8, the staple execution 1005 is an attribute that relates to an error status. Hence, when there is an error that stapling cannot be performed included as an error status in the received device status notification, a one-touch button for which the staple execution 1005 is set to “Yes” is determined to be a button relating to error status. In contrast, a one-touch button for which the staple execution 1005 is not set to “Yes” is determined to be a button that does not relate to error status. According to the aforementioned example, the display candidates at this time are the two one-touch buttons with the button IDs “004” and “009”. There is no one-touch button among these display candidates for which the staple execution 1005 is set to “Yes”, and thus it is decided that neither of the one-touch buttons with the button IDs “004” and “009” relate to error status.

In the aforementioned S1118, if it is determined that there is a button relating to the received error status, the button grouping decision section 207 proceeds to the processing in step S1119. In contrast, in S1118, if it is determined that there is no button relating to the received error status, the button grouping decision section 207 notifies the display screen generation section 205 to that effect, and the display screen generation section 205 proceeds to the processing in step S1123.

In step S1119, the button grouping decision section 207 decides to display the buttons among the display candidates that do not relate to the received device status as they are as one-touch buttons (display on the upper level). More specifically, the button grouping decision section 207 decides to retain the buttons that do not relate to the received device status as display candidates. According to the aforementioned example, the button grouping decision section 207 decides to display the one-touch buttons with the button IDs “004” and “009” that are display candidates as they are.

Next, in step S1120, the button grouping decision section 207 decides to display buttons that relate to error status among the one-touch buttons indicated by the display button information as a single “summary button” (display on a lower level). The button grouping decision section 207 then notifies the result determined in the aforementioned S1119 and S1120 to the display screen generation section 205.

Next, in step S1121, according to the decision in the above described S1120, the display screen generation section 205 associates zero or more one-touch buttons that are not to be displayed (to be displayed as a summary button) and a “summary button”, and stores the result in the button grouping table 211.

Further, in step S1122, according to the decisions in the above described S1119 and S1120, the display screen generation section 205 updates the display screen information of the screen information storage section 208. According to the aforementioned example, the display screen generation section 205 updates the information of the screen information storage section 208 so as to display the two buttons with the button IDs “004” and “009” as they are as one-touch buttons, and to display “printer” and “staple” as summary buttons.

Next, in step S1123, according to the information of the screen information storage section 208 that is updated in the aforementioned S1107, S1112, S1117, or S1122, the display screen generation section 205 sends the screen data to be displayed to the device. According to the above described example, the screen data displays the buttons with the button IDs “004” and “009” as they are as one-touch buttons. Further, the screen data displays the buttons with the button IDs “001” and “008” as a “scan” summary button. Furthermore, the screen data displays the buttons with the button IDs “002”, “003”, “005”, “006”, and “007” as a “print” summary button.

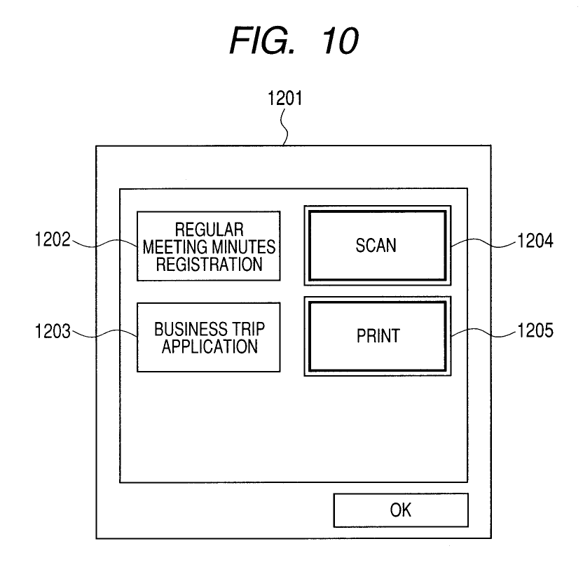

The device that receives the screen data sent by the PC application 102 in the aforementioned S1123 displays an operation screen as shown in FIG. 10 on the UI 302 based on the received information.

FIG. 10 is a view that illustrates a screen display example according to Embodiment 1.

In FIG. 10, a screen 1201 is a touch panel that is a display area of a screen mounted on a device. As described with the flowchart in FIG. 9, two one-touch buttons 1202 and 1203 are displayed on the screen 1201. The button ID of the one-touch button 1202 “Regular Meeting Minutes Registration” is “004”. The button ID of the one-touch button 1203 “Business Trip Application” is “009”.

Further, a “scan” summary button 1204 that summarizes one-touch buttons for which the processing kind 1002 is “scan” and a “print” summary button 1205 that summarizes one-touch buttons for which the processing kind 1002 is “print” are displayed on the screen 1201.

According to the present embodiment, since the number of buttons displayed on the screen 1201 in this manner (i.e. the upper level) is small, the tabs that are displayed on the conventional screen examples (FIG. 13 and FIG. 14) are unnecessary, and a user can easily select a desired button among the small number of buttons.

When one of the aforementioned summary buttons is designated (pressed) at the device, the device notifies the PC application 102 to that effect. The display screen generation section 205 of the PC application 102 that receives the notification generates display screen information of an operation screen that displays only the buttons that are summarized under the relevant summary button, stores the display screen information in the screen information storage section 208, and sends the display screen information to the device (operation screen regeneration processing). Upon receiving the display screen information, the device updates the display screen management section 402 with the received display screen information, updates the screen of the UI 302 with the received display screen information, and accepts an operation from the user.

As described above, by pressing the “print” summary button 1205 on the screen shown in FIG. 10, only the one-touch buttons that have been associated with the “print” summary button 1205 are individually displayed in a hierarchical manner.

According to the present embodiment, since grouping processing for grouping buttons is performed as occasion arises based on static information (login user information and device capability) and information that changes dynamically (device status), a user interface with enhanced operability can be provided.

### Embodiment 2

According to the above described Embodiment 1, a configuration was described in which, upon receiving a notification that a summary button has been designated, the PC application 102 regenerates display screen information that displays only buttons that are summarized under the relevant summary button (operation screen regeneration processing of Embodiment 1 ).

According to Embodiment 2, at the time of operation screen regeneration processing, based on device capability information and device status information that is managed with the device information management section 202, a decision is made again regarding whether to again summarize and display any of the buttons that have been summarized under the relevant summary button. Buttons are then re-summarized according to the result of the re-decision, and the display screen is regenerated.

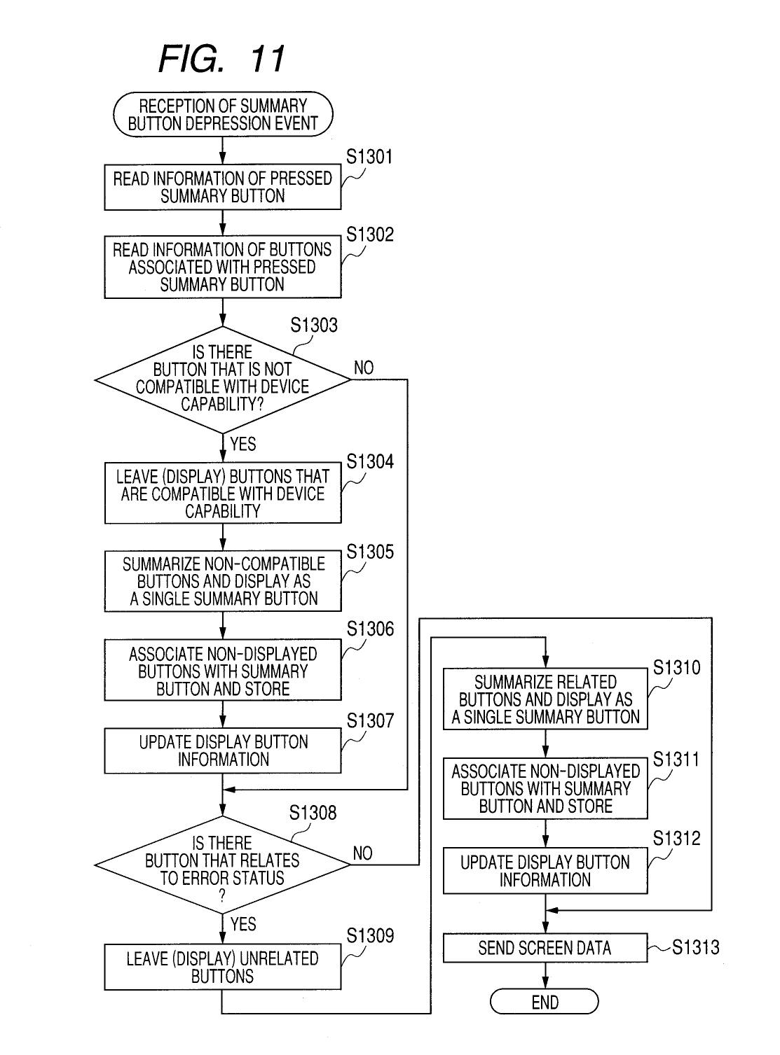

Hereunder, operations are described in a case in which a summary button is pressed according to Embodiment 2. FIG. 11 is a flowchart that illustrates the operations of the PC application 102 of Embodiment 2 when a summary button is pressed.

When the PC application 102 is notified by the device that a summary button has been pressed, the display screen generation section 205 of the PC application 102 executes the following processing.

First, in step S1301, the display screen generation section 205 reads out the information of the pressed summary button from the screen information storage section 208. In this case, an example is described in which the “print” summary button 1205 in FIG. 10 has been pressed.

In step S1302, the display screen generation section 205 reads out information of buttons associated with the pressed summary button from the information read out in the aforementioned S1301, from the button grouping table 211 via the button grouping decision section 207 and makes the relevant buttons the display candidates. In the above example, the one-touch buttons for which the processing kind 1002 is “print” are associated with the “print” summary button 1205. In the button grouping decision table shown in FIG. 8, five one-touch buttons with the button IDs “002”, “003”, “005”, “006”, and “007” are associated with the “print” summary button 1205 and are thus display candidates.

In step S1303, the display screen generation section 205 causes the button grouping decision section 207 to determine whether or not there is a button that is not compatible with the device capability managed by the device information management section 202 among the above described display candidates. The decision method is the same as that described above with respect to S1113 in FIG. 9. In the above S1303, when it is decided that there is a one-touch button that is not compatible with the device capability, the button grouping decision section 207 proceeds to the processing of step S1304. In contrast, if it is decided that there is no one-touch button that is not compatible with the device capability, the button grouping decision section 207 notifies the display screen generation section 205 to that effect, and the display screen generation section 205 proceeds to the processing in step S1308. In this connection, in the button grouping decision table in FIG. 8, the OCR processing 1004 is an attribute that is influenced by the device capability. According to the above example, the setting for the OCR processing 1004 is “no” for each of the five one-touch buttons that have the button IDs “002”, “003”, “005”, “006”, and “007” that are the display candidates, and it is therefore decided that there are no buttons that are not compatible with the device capability.

Next, in step S1304, similarly to S1114 in FIG. 9, the button grouping decision section 207 decides to display the buttons compatible with the device capability among the display candidates as they are as one-touch buttons (display on the upper level). More specifically, the button grouping decision section 207 decides to retain the compatible buttons as display candidates. According to the above example, it is decided not to summarize the five buttons with the button IDs “002”, “003”, “005”, “006”, and “007” that are display candidates because the buttons are compatible with the device capability.

Next, in step S1305, similarly to S1115 in FIG. 9, the button grouping decision section 207 decides to display buttons that are not compatible with the device capability among the display candidates as a single “summary button” (display on a lower level). The button grouping decision section 207 then notifies the results determined in the aforementioned S1304 and S1305 to the display screen generation section 205.

In step S1306, similarly to S1116 in FIG. 9, according to the decision in the above described S1305, the display screen generation section 205 associates zero or more one-touch buttons that are not to be displayed (to be displayed as a summary button) and a “summary button”, and stores the result in the button grouping table 211.

In this connection, the method of summarizing buttons when summarizing the buttons in the above S1306 is according to attributes in the button grouping decision table that are not compatible with the device capability. For example, when the device capability does not include OCR processing, one-touch buttons for which the OCR processing 1004 is set to “Yes” are summarized as an “OCR” summary button. In this case, since it is known that OCR processing cannot be performed based on the device capability, the “OCR” summary button is displayed (arranged) as a button that cannot be operated.

Further, in step S1307, similarly to S1117 in FIG. 9, the display screen generation section 205 updates the display screen information of the screen information storage section 208 according to the decisions in the above described S1304 and S1305. At this time, the display screen information is generated such that the “summary button” is displayed as a button that cannot be operated. The display candidates are also updated at this time. According to the above example, the display candidates at this time are the five buttons with the button IDs “002”, “003”, “005”, “006”, and “007”.

Next, in step S1308, the display screen generation section 205 causes the button grouping decision section 207 to decide whether or not there is a button among the display candidates that relates to an error status that is managed by the device information management section 202. As described above with respect to the device status notification 907 in FIG. 7, in the button grouping decision table in FIG. 8, the staple execution 1005 is an attribute that relates to the error status. Hence, when there is an error status that stapling cannot be performed included in the device status, a one-touch button for which the staple execution 1005 is set to “Yes” is determined to be a button relating to the error status. In contrast, a one-touch button for which the staple execution 1005 is not set to “Yes” is determined to be a button that does not relate to the error status. According to the aforementioned example, it is found that among the five buttons that are display candidates as described above, the one-touch buttons for which the staple execution 1005 is set to “Yes” are the buttons with the button IDs “003” and “006”. Hence, it is determined that the one-touch buttons with the button IDs “003” and “006” relate to the error status.

In the aforementioned S1308, when it is determined that there is a button relating to the error status, the button grouping decision section 207 proceeds to the processing in step S1309. In contrast, in S1308, if it is determined that there is no button relating to the error status, the button grouping decision section 207 notifies the display screen generation section 205 to that effect, and the display screen generation section 205 proceeds to the processing in step S1313.

In step S1309, similarly to S1119 in FIG. 9, the button grouping decision section 207 decides to display the buttons among the display candidates that do not relate to the error status as they are as one-touch buttons (display on the upper level). More specifically, the button grouping decision section 207 decides to retain the buttons that do not relate to the error status as display candidates. According to the aforementioned example, the button grouping decision section 207 decides to display the one-touch buttons with the button IDs “002”, “005” and “007” that are display candidates as they are.

Next, in step S1310, similarly to S1120 in FIG. 9, the button grouping decision section 207 decides to display buttons that relate to the error status among the one-touch buttons indicated by the display button information as a single “summary button” (display on a lower level). In the above example, the button grouping decision section 207 decides to display buttons with the button IDs “003” and “006” that are display candidates as a single summary button.

In this connection, the method of summarizing buttons when summarizing the buttons in the above S1310 is according to attributes in the button grouping decision table that are relate to error status. For example, in the case of a staple error, one-touch buttons for which the staple execution 1005 is set to “Yes” are summarized as a “staple” summary button. In this case, since it is known that staple execution cannot be performed, the “staple” summary button is displayed (arranged) as a button that cannot be operated. The button grouping decision section 207 notifies the results determined in the above S1308 and S1309 to the display screen generation section 205.

Next, in step S1311, similarly to S1121 in FIG. 9, the display screen generation section 205 associates zero or more one-touch buttons that are not to be displayed (displayed as a summary button) and a “summary button” according to the decision in the above S1310, and stores the result in the screen information storage section 208. According to the above example, the buttons with the button IDs “003” and “006” are associated with the “staple” summary button and stored.

Further, in step S1312, similarly to S1117 in FIG. 9, the display screen generation section 205 updates the display screen information of the screen information storage section 208 according to the decisions in the above described S1308 and S1309. At this time, the display screen information is generated such that the “summary button” is displayed as a button that cannot be operated. According to the above example, the information of the screen information storage section 208 is updated such that the buttons with the button IDs “002”, “005”, and “007” are displayed as one-touch buttons and the buttons with the button IDs “003” and “006” are displayed as a “staple” summary button that cannot be operated.

Next, in step S1313, the display screen generation section 205 sends screen data to be displayed that is according to information of the screen information storage section 208 that is updated in the aforementioned S1307 or S1312 to the device.

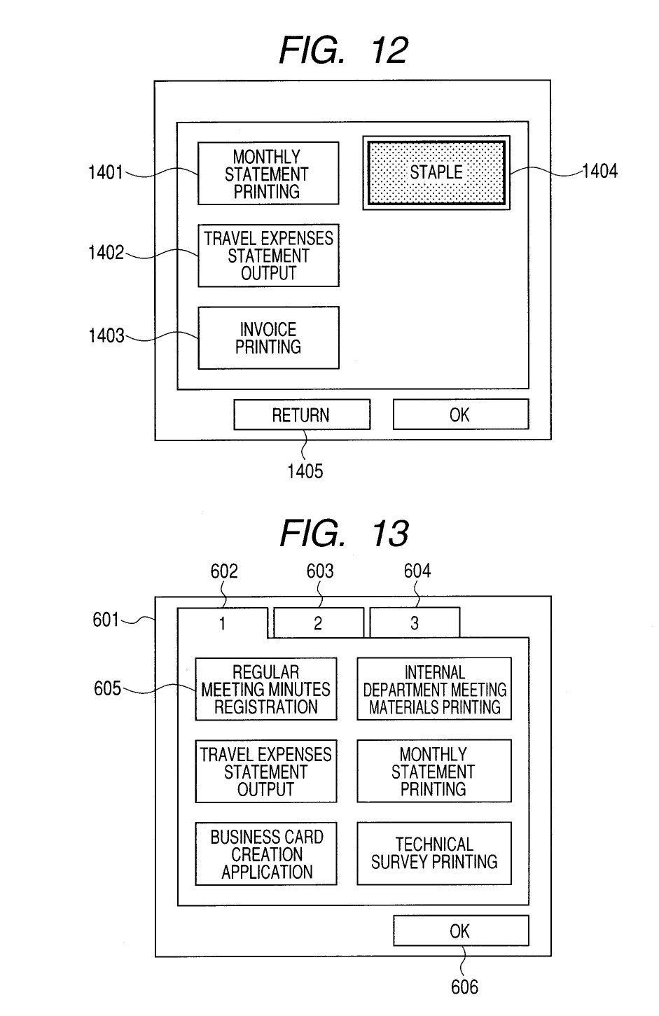

The display screen management section 402 of the device that receives the screen data sent by the PC application 102 in the aforementioned S1313 displays a screen as shown in FIG. 12 on the UI 302 based on the received screen data.

FIG. 12 is a view that illustrates a screen display example in a case where the “print” summary button 1205 on the screen shown in FIG. 10 has been pressed.

As described according to the flowchart in FIG. 11, three one-touch buttons 1401, 1402, and 1403 are displayed. Button 1401 is a button “Monthly Statement Printing” with the button ID “002”, button 1402 is a button “Travel Expenses Statement Output” with the button ID “005”, and button 1403 is a button “Invoice Printing” with the button ID “007”.

Further, a “staple” summary button 1404 is displayed. The “staple” summary button 1404 is a button that summarizes a “Print Internal Department Meeting Materials” button with the button ID “003” and a “Technical Survey Printing” button with the button ID “006”.

As described above, by pressing the “print” summary button 1204 on the screen shown in FIG. 10, only the one-touch buttons that have been associated with the “print” summary button 1204 are individually displayed in a hierarchical manner as shown in FIG. 12. Further, by performing a button grouping decision again at the time of forming the display information, buttons for which there is a higher possibility of being selected by the user can be displayed.

### Embodiment 3

This embodiment describes control of timing at which to cancel the display of a summary button.

A user can set the timing at which to cancel the display state of a summary button from the UI 302 of the device, or from the PC 101, or from another PC that can communicate with the PC 101. The setting is stored and managed for each user in the user information management section 203 of the PC 101. The following two settings are available with respect to the timing at which to cancel the display state of a summary button.

First setting: when a fixed time period elapses without a button operation being performed by the user while the screen is displayed, the screen switches to a screen that displays all buttons.

Second setting: after a button is pressed and processing is completed, the screen switches to a screen that displays all buttons.

In the case of the first setting, the following two settings are further available: a setting that switches to display all buttons at once; and a setting that gradually switches to display all buttons from a summary button display state. The case of the setting that gradually switches to display all buttons is described below.

Similarly to the above example, it is assumed that User A has logged in and the operation screen (FIG. 10) generated by the processing illustrated in FIG. 9 is being displayed. More specifically, the one-touch buttons with the button IDs “004” and “009” and the “scan” summary button and the “print” summary button are being displayed on the UI 302 of the device. When a predetermined time period (for example, 5 seconds) elapses without the user performing a button operation, the PC application 102 cancels the decision made based on the login user information. More specifically, the PC application 102 performs the processing of S1101 and S1108 to S1123 in FIG. 9 to generate a new display screen and send the display screen to the device. That is, the display screen changes to a display screen that is generated by making a decision based on the user operation status, the device capability, and the device status. According to the aforementioned example, as a result of this processing, one-touch buttons with the button IDs “001”, “004”, and “009” and summary buttons for which the processing kind 1002 is “scan” or “print” are respectively displayed on the UI 302 of the device. More specifically, a “Business Card Creation Application” button with the button ID “001” is newly displayed. If the user wishes to make a “Business Card Creation Application”, the user can execute the processing by pressing this button.

Further, when a predetermined time period (for example, 5 seconds) elapses without the user performing a button operation, the PC application 102 cancels the decision regarding the user operation status and switches to a screen that displays all buttons.

In this connection, it is assumed that when a button on the operation screen is operated by the user, the device notifies the PC application 102 to that effect. Hence, when there is no notification of a user operation as described above during the time period from when the PC application 102 sends an operation screen to the device until the predetermined time period elapses, the PC application 102 decides that the predetermined time period has elapsed without a user operation being performed.

The first setting and the second setting are both settings that cancel the display of summary buttons and switch to a full screen display, and in each case a configuration may be adopted that summarizes non-executable buttons as a summary button. More specifically, the PC application 102 may be configured to perform the processing of S1101 and S1113 to S1123 in FIG. 9 to generate a new display screen and send the new display screen to the device. That is, a configuration may be adopted such that a decision is made based on the device capability and device status, and the screen is changed to a display screen generated thereby. According to the above described example, the one-touch buttons with the button IDs “001”, “002”, “004”, “005”, “007”, “008”, and “009” and the “staple” summary button are displayed on the UI 302 of the device. The “staple” summary button is displayed in an inoperable state.

According to the above configuration, with the first setting, even if a one-touch button desired by the user is not displayed on the generated operation screen, an operation screen can be provided in which the conditions are gradually cancelled. As a result, it is possible to gradually provide an operation screen on which a one-touch button desired by the user is displayed while gradually increasing the number of display buttons.

Thus, according to the foregoing embodiments, by grouping a plurality of buttons that are considered to be not desired by a user and displaying the group of buttons as a single button, it is possible to reduce the number of buttons that are displayed and thereby make it easier for a user to find a desired button.

Further, since only the relevant group of buttons is displayed when a button that represents a group of buttons is pressed, it is possible to realize a hierarchical display of buttons, and thus a large number of buttons can be efficiently displayed in a small area.

Further, the grouping decision can be made by taking into consideration not only static information such as the processing contents corresponding to the buttons, the device capability, and user information, but also dynamic information such as a device error status and a user operation status. It is thereby possible to display buttons which have a high possibility of corresponding to the circumstances in question, and thus a user interface with enhanced operability can be provided.

According to the foregoing embodiments, there can be provided a user interface with enhanced operability that can suitably reduce the number of buttons displayed on an operation screen of a device to allow a user to easily find and operate a desired button.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-112279, filed on May 1, 2009, which is hereby incorporated by reference herein in its entirety.

What is claimed is:

1. An image processing system comprising an image processing device, and an information processing apparatus that generates an operation screen of the image processing device and sends the operation screen to the image processing device,
wherein the information processing apparatus comprises:
a registration unit configured to register processing executed by the image processing device as a button;
a device information acquisition unit configured to acquire device information of the image processing device from the image processing device;
a decision unit configured to decide a hierarchy for displaying buttons registered in the registration unit based on device information acquired by the device information acquisition unit and contents of processing corresponding to buttons registered in the registration unit;
a button summarizing unit configured to group a plurality of buttons which the decision unit decides to display on a lower level into one or more groups, and make one summary button correspond to each group; and
a screen generation unit configured to generate operation screen information for displaying a button that the decision unit decides to display on an upper level and the summary button that has been summarized by the button summarizing unit on an operation screen, and send the operation screen information to the image processing device, and
wherein the image processing device comprises:
a device information notification unit configured to notify device information of the image processing device to the information processing apparatus; and
a user interface unit configured to display an operation screen based on operation screen information received from the information processing apparatus and accept a user operation.

2. A device operation screen generation method carried out in an information processing apparatus that registers contents of processing executed by an image processing device as buttons, generates an operation screen to be displayed on an user interface of the image processing device using buttons that are registered, and sends the operation screen to the image processing device, the method comprising:
a device information acquisition step of acquiring device information of the image processing device from the image processing device
a decision step of deciding a hierarchy for displaying of the registered buttons based on device information acquired in the device information acquisition step and contents of processing corresponding to buttons registered at the information processing apparatus;
a button summarizing step of grouping a plurality of buttons for which the decision has been made to display on a lower level in the decision step into one or more groups, and making one summary button correspond to each group; and
a screen generation step of generating operation screen information for displaying a button for which a decision has been made to display on an upper level in the decision step and the summary button that has been summarized in the button summarizing step on an operation screen, and sending the operation screen information to the image processing device.

3. A method according to claim 2, wherein the device information of the image processing device includes capability information of the image processing device and error status information of the image processing device, and wherein the decision step decides to display on an upper level buttons that correspond to processing that can be executed by the image processing device and decides to display on a lower level buttons that correspond to processing contents that cannot be executed by the image processing device with respect to buttons registered in the information processing apparatus, based on capability information of the image processing device and error status information of the image processing device.

4. A method according to claim 3, wherein the screen generation step generates the operation screen information so as to display in an inoperable state a summary button of the buttons that correspond to processing that cannot be executed.

5. A method according to claim 2, wherein the device information of the image processing device includes user operation status information that shows information of a status change of the image processing device caused by a user operation at the image processing device, and wherein the decision step decides to display a button corresponding to processing relating to the user operation status on an upper level, and decides to display a button corresponding to processing that does not relate to the user operation status on a lower level.

6. A method according to claim 2, further comprises a user information acquisition step of acquiring user information of a user that has logged in to the image processing device, wherein the decision step decides to display a button corresponding to processing relating to user information acquired in the user information acquisition step on an upper level, and decides to display a button corresponding to processing contents that do not relate to the user information on a lower level.

7. A method according to claim 2, wherein the button summarizing step groups a plurality of buttons for which a decision has been made to display on a lower level in the decision step, based on processing contents.

8. A method according to claim 2, wherein the decision step, the button summarizing step, and the screen generation step are executed each time device information of the image processing device is acquired in the device information acquisition step.

9. A method according to claim 2, further comprising an operation screen regeneration step of, in a case where a notification indicating that the summarized button has been designated is received from the image processing device, generating operation screen information that displays only buttons summarized under the button and sending the operation screen information to the image processing device.

10. A method according to claim 2, further comprising:
a re-decision step of, in a case in which a notification indicating that the summarized button has been designated is received from the image processing device, dynamically deciding a hierarchy for displaying the summarized button based on the device information and contents of processing corresponding to buttons summarized under the summary button that is designated;
a button re-summarizing step of further grouping a plurality of buttons for which a decision has been made to display on a lower level in the re-decision step into one or more groups, and making one re-summary button correspond to each group, respectively; and
an operation screen regeneration step of generating operation screen information for displaying a button for which a decision has been made to display on an upper level in the re-decision step and the re-summary button that is re-summarized in the button re-summarizing step on an operation screen, and sending the operation screen information to the image processing device.

11. A method according to claim 2, further comprising:
a detection step of detecting that a predetermined time period has elapsed without an operation of the button or the summary button being performed at the image processing device; and
a summary button display cancellation step of, in a case where it is detected in the detection step that a predetermined time period has elapsed without an operation of the button or the summary button being performed, generating operation screen information that displays all of the registered buttons, and sending the operation screen information to the image processing device.

12. A method according to claim 2, further comprising:
a detection step of detecting that a predetermined time period has elapsed without an operation of the button or the summary button being performed at the image processing device; and
a summary button display cancellation step of, each time it is detected in the detection step that a predetermined time period has elapsed without an operation of the button or the summary button being performed, gradually increasing a number of buttons displayed on the operation screen, generating the operation screen information, and sending the operation screen information to the image processing device.

13. A method according to claim 2, further comprising a summary button display cancellation step of, in a case where a notification that the button has been designated and processing corresponding to the button has been executed is received from the image processing device, generating operation screen information that displays all of the registered buttons, and sending the operation screen information to the image processing device.

14. A computer-readable storage medium that stores a program that causes a computer to execute a method according to claim 2.

15. An information processing apparatus, comprising:
a registration unit configured to register processing executed by an image processing device as a button;
a device information acquisition unit configured to acquire device information of the image processing device from the image processing device;
a decision unit configured to decide a hierarchy for displaying buttons registered by the registration unit based on device information acquired by the device information acquisition unit and contents of processing corresponding to buttons registered by the registration unit;
a button summarizing unit configured to group a plurality of buttons which the decision unit decides to display on a lower level into one or more groups, and make one summary button correspond to each group; and
a screen generation unit configured to generate operation screen information for displaying a button that the decision unit decides to display on an upper level and the summary button that has been summarized by the button summarizing unit on an operation screen, and send the operation screen information to the image processing device.
